(19) United States
(12) Patent Application Publication
(10) Pub. No.: US 2008/0111823 A1
(43) Pub. Date: May 15, 2008

(54) GRAPHICS PROCESSING SYSTEM

(75) Inventors: Yang-Je Fan, Taipei County (TW); Chun-Hung Lin, Taipei County (TW); Tzu-Lan Shen, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FARADAY TECHNOLOGY CORP., Hsin-Chu City (TW)

(21) Appl. No.: 11/558,948

(22) Filed: Nov. 13, 2006

(51) Int. Cl. G09G 5/39

(52) U.S. Cl. 345/531

(57) ABSTRACT

A graphics processing system for processing an input image to an output image. A memory buffer includes a number of line buffers for storing the input image. A sampling controller samples sampling points of the input image, scales the input image by a sampling polynomial equation, and generates a scaled image. A window filter filters the scaled image by a filter polynomial equation to generate the output image. A memory controller determines the number of the line buffers according to the sampling polynomial equation and the filter polynomial equation.

### BACKGROUND OF THE INVENTION

1. Field of the Invention

The invention relates to a graphics processing system, and in particular relates to a graphics processing system with configurable line buffers for image scaling and filtering.

2. Description of the Related Art

Video and graphics systems are typically used in television control electronics, such as set top boxes, integrated digital TVs, and home network computers. Video and graphics systems typically include a graphics processing system that may perform image processing functions.

There are many types of video displays and many types of formats for video displays and within the displays themselves there are many modes. For example, for a computer there are VGA, SVGA and XGA displays, all of which have differing numbers of lines and columns. It is often desirable at times to have multimedia presentations with different parts of the screen carrying different images, and, therefore, there is need to change the number of lines and columns for a given video display. Further, a proposed new High Definition TV Standard (HDTV) has as many as 1920 columns×1080 lines. Still further, there are in addition to CRT displays, other forms of displays like flat panels. Within the operation of such a system, it may be desirable to have a panoramic view, a wide screen view, or a movie screen view, again, requiring some modification of the number of lines of the video signal from a source to the number of lines in the output signal. This is achieved by some form of image scaling. Here, a memory buffer is employed to store the image for scaling.

In addition, another image processing method adjusts an image by window filtering to increase image resolution. Window filtering is performed by applying the image to a filter matrix, which adjusts the image according to a filter polynomial equation. Here, another memory buffer is required for image filtering.

### BRIEF SUMMARY OF INVENTION

Graphics processing systems for processing an input image to an output image are provided. An exemplary embodiment of the graphics processing system comprises a memory buffer comprising a first number of a plurality of line buffers for storing the input image, a sampling controller sampling a plurality of sampling points of the input image, scaling the input image by a sampling polynomial equation, and generating a scaled image, a first window filter filtering the scaled image by a first filter polynomial equation to generate the output image, and a first memory controller determining the first number of the line buffers according to the sampling polynomial equation and the first filter polynomial equation.

Another exemplary embodiment of the graphics processing system comprises a memory buffer comprising a first number of a plurality of line buffers for storing the input image, a sampling unit sampling a plurality of sampling points of the input image, a scaling unit scaling the sampling points by a sampling polynomial equation, a local memory for storing data corresponding to the scaled sampling points and a portion of the input image, a first window filter filtering the data corresponding to the scaled sampling points and the portion of the input image by a first filter polynomial equation to generate the output image; and a first memory controller configuring the local memory according to the sampling polynomial equation and the first filter polynomial equation.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an embodiment of a graphics processing system 10;

FIG. 2 is a data saturate of memory buffer 12 according to an embodiment of the invention;

FIG. 3 is a block diagram of sampling controller 20 according to an embodiment of the invention.

FIG. 4 is a data saturate of local memory 26 according to an embodiment of the invention; and

FIG. 5 is a table showing examples of the relationship among memory height H, degree D1 of the sampling polynomial equation, and the degree D2 of the filter polynomial equation.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

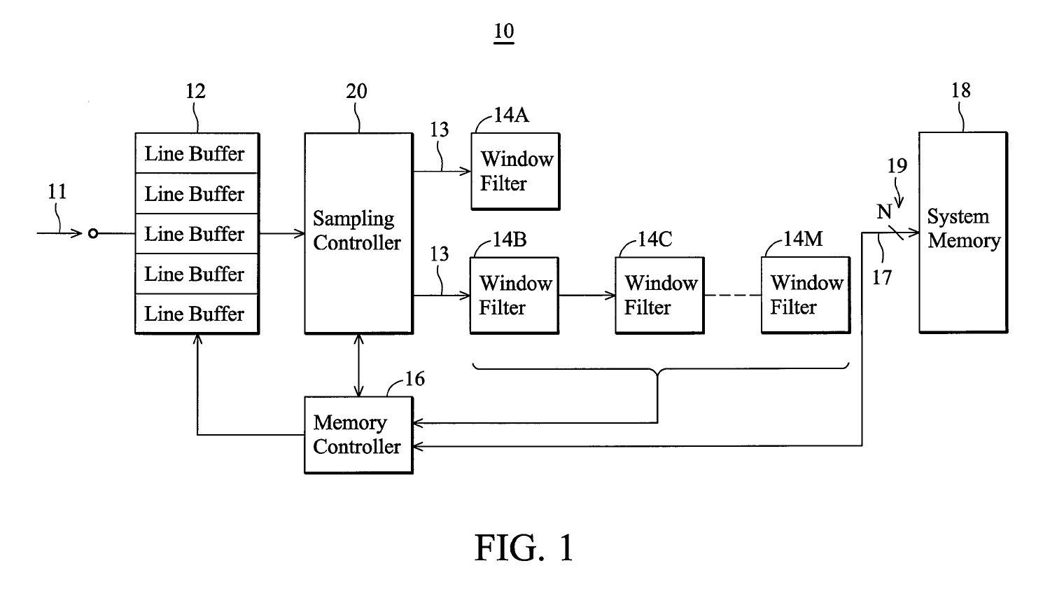

FIG. 1 is a block diagram of an embodiment of a graphics processing system 10. Graphics processing system 10 for processing an input image 11 to an output image 17 according to an embodiment of the invention comprises a memory buffer 12, a sampling controller 20, window filters 14A˜14M, a memory controller 16 and a system memory 18.

Memory buffer 12 stores the input image 11. Sampling controller 20 samples a plurality of sampling points of the input image 11, scales the sampled input image 11 by a sampling polynomial equation, and generates a scaled image 13. Hare, the sampling polynomial equations in x direction and y direction can be:

x̅(i,j)=a₀+a₁x(i−n,j)+ . . . +aₙx(i+n,j) (1)

y̅(i,j)=b₀+b₁y(i, j−n)+ . . . +bₙy(i,j+n) (2)

where x(i,j) and y(i,j) are original points, x̅(i,j) and y̅(i,j) are the scaled points, a₀˜a₁ and b₀˜bₙ are scaling coefficients respectively for x direction and y direction, and parameter n represents the degree of the polynomial equation.

Window filters 14A˜14M, each filters the scaled image 13 by a predetermined filter polynomial equation to generate output image 17. One example of the filter polynomial equation with 3 degree for sampled point (1,1) can be:

$$\overline{x} ( 1 , 1 ) = [ \begin{matrix}{a}_{00} & {a}_{01} & {a}_{01} \\ {a}_{10} & {a}_{11} & {a}_{12} \\ {a}_{20} & {a}_{21} & {a}_{22}\end{matrix} ] [ \begin{matrix}{x}_{00} & {x}_{01} & {x}_{01} \\ {x}_{10} & {x}_{11} & {x}_{12} \\ {x}_{20} & {x}_{21} & {x}_{22}\end{matrix} ] + [ \begin{matrix}{b}_{0} \\ {b}_{1} \\ {b}_{2}\end{matrix} ] \qquad ( 3 )$$

where parameters a and b are predetermined filter-polynomial coefficients. Note that window filter for processing the scaled image 13 can be a single filter, such as window filter 14A, or a cascade structure, such as window filters 14B-14M.

The output image 17 output from window filters 14A or 14M is stored in a system memory 18 through a bus 19 with a bus bandwidth (N bits). Noted that the scaling coefficients and filter-polynomial coefficients can be programmed or load from system 18.

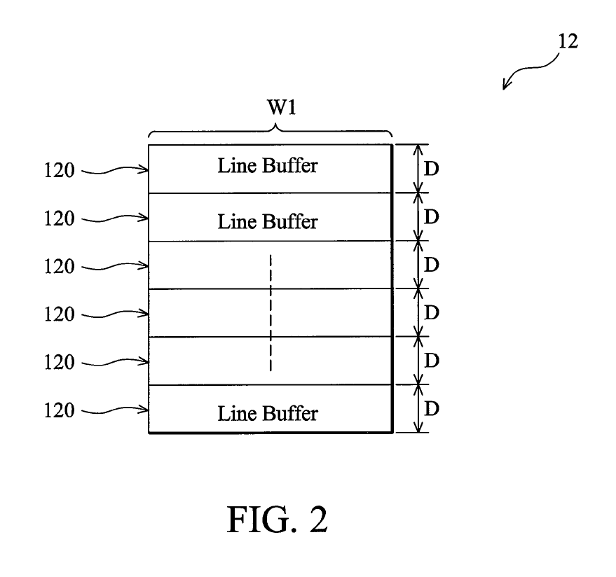

FIG. 2 is a data saturate of memory buffer 12 according to an embodiment of the invention. Memory buffer 12 comprises a plurality of line buffers 120 for storing the input image 11. In an embodiment of the invention, the number of the line buffers can be configurable by memory controller 16 according to the degree of the sampling polynomial equation and the filter polynomial equation. In an embodiment of the invention, the number of the line buffers is defined as the largest degree between the sampling polynomial equation and the filter polynomial equation. For example, the number of the line buffers is the degree of sampling polynomial equation when the degree of the sampling polynomial equation exceeds that of the filter polynomial equation, and is the degree of the filter polynomial equation when the degree of the filter polynomial equation exceeds that of the sampling polynomial equation.

The line buffer 120 comprises buffer width W1 and buffer depth D. The buffer width W1 is determined according to the bus bandwidth of the bus 19 of the system memory 18. For example, the buffer width W1 of line buffer 120 and the bus bandwidth of system memory 18 are the same, both N bits. In addition, the buffer depth D is determined according to an image width of maximum resolution of the input image 11.

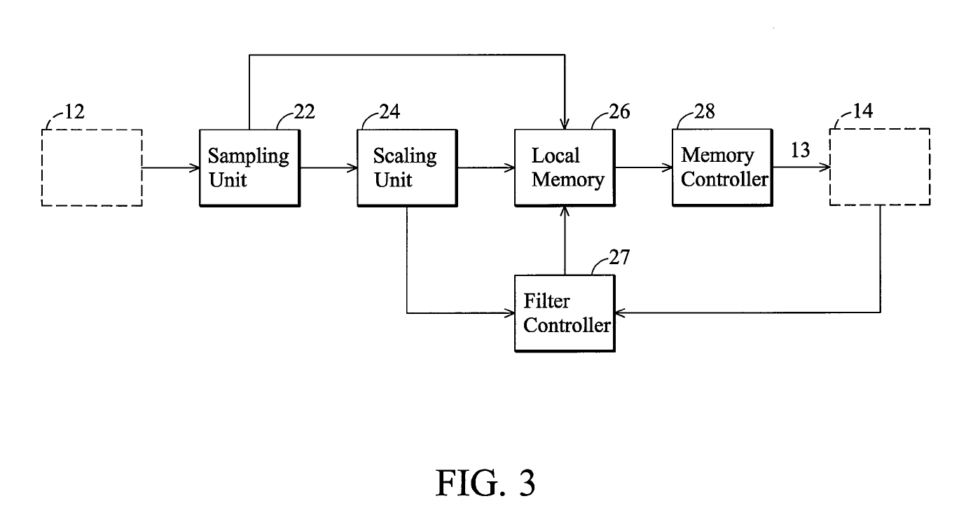

FIG. 3 is a block diagram of sampling controller 20 according to an embodiment of the invention. The sampling controller 20 comprises a sampling unit 22, a scaling unit 24, a local memory 26, a memory controller 27 and a filter controller 28.

The sampling unit 22 samples the sampling points of the input image 11 in one of the line buffers 120. In an embodiment of the invention, the number of the sampling points sampled by sampling unit 22 can be determined according to the degree of the sampling polynomial equation and the filter polynomial equation. In an embodiment of the invention, the number of the sampling points is defined as the largest degree between the sampling polynomial equation and the filter polynomial equation. For example, the number of the sampling points is the degree of sampling polynomial equation when the degree of the sampling polynomial equation exceeds that of the filter polynomial equation, and is the degree of the filter polynomial equation when the degree of the filter polynomial equation exceeds that of the sampling polynomial equation.

The scaling unit 24 scales the sampling points of the input image 11 in one of the line buffers 120 according to the sampling polynomial equation, and stores the data corresponding to the scaled sampling points to a local buffer of local memory 26.

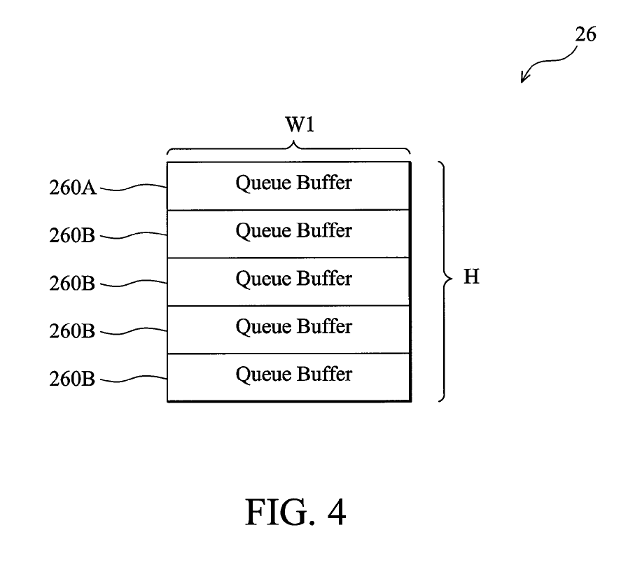

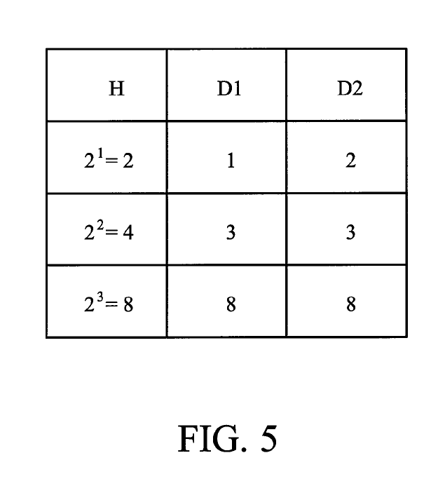

FIG. 4 is a data saturate of local memory 26 according to an embodiment of the invention. Local memory 26 has configurable buffer width W2 and memory height H, and comprises a plurality of local queue buffers 260A and 260B. In an embodiment of the invention, the memory height H can be configured by memory controller 27 according to the degree of the sampling polynomial equation and the filter polynomial equation. In an embodiment of the invention, the memory height H is the power of 2 and exceeds or is equal to the degree of the sampling polynomial equation and the filter polynomial equation. FIG. 5 is a table showing examples of the relationship among memory height H, degree D1 of the sampling polynomial equation, and the degree D2 of the filter polynomial equation. In example I, memory height H is 2 (=2¹) when the degree D1 of the sampling polynomial equation is 1 and the degree D2 of the filter polynomial equation is 2. In example II, memory height H is 4 (=2²) when D1 is 3 and D2 is 2, and in example III, memory height H is 8 (=2³) when D1 is 8 and D2 is 8. In another embodiment, local memory 26 can be configured by the memory controller 16, such that the memory controller 27 can be eliminated.

Local queue buffer 260A of local memory 26 stores the data corresponding to the scaled sampling points, sampled from one of the line buffers 120, and local queue buffers 260B store the original input image 11 sampled from the other line buffers 120 by sampling unit 22. In addition, the data stored in local queue buffers 260B may be applied to a source to filter equation, combined with the data corresponding to the scaled sampling points, and output together by filter controller 28 to window filters 14A and/or 14B.

Accordingly, the invention shares image scaling and window filter hardware by combining their control logic circuits to reduce line buffer usage efficiently, sampling hardware requirement and design complexity.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A graphics processing system for processing an input image to an output image, comprising:
a memory buffer comprising a first number of a plurality of line buffers for storing the input image;
a sampling controller sampling a plurality of sampling points of the input image, scaling the input image by a sampling polynomial equation, and generating a scaled image;
a first window filter filtering the scaled image by a first filter polynomial equation to generate the output image; and
a first memory controller determining the first number of the line buffers according to the sampling polynomial equation and the first filter polynomial equation.

2. The graphics processing system as claimed in claim 1, wherein the sampling polynomial equation is a first degree and the first filter polynomial equation is a second degree.

3. The graphics processing system as claimed in claim 2, wherein the first number of the line buffers is determined according to the first degree and the second degree.

4. The graphics processing system as claimed in claim 2, wherein the number of the sampling points is determined according to the first degree and the second degree.

5. The graphics processing system as claimed in claim 1, wherein the line buffer has a buffer width and a buffer depth.

6. The graphics processing system as claimed in claim 5, wherein the output image is stored in a system memory through a bus with a bus bandwidth.

7. The graphics processing system as claimed in claim 6, wherein the buffer width is determined according to the bus bandwidth.

8. The graphics processing system as claimed in claim 5, wherein the buffer depth is determined according to an image width of the input image.

9. The graphics processing system as claimed in claim 5, wherein the sampling controller comprises:
a sampling unit sampling the sampling points of the input image in one of the line buffers;
a scaling unit scaling the sampling points sampled by the sampling unit according to the sampling polynomial equation;
a local memory comprising a plurality of local buffers, wherein one of the local buffer stores data corresponding to the scaled sampling points, and the other local buffers store the input image corresponding to the others line buffers; and
a filter controller outputting data stored in the local memory to the first window filter.

10. The graphics processing system as claimed in claim 9, wherein the local memory has the buffer width, and a memory height of the power of 2 and exceeding or equal to the first degree and the second degree.

11. The graphics processing system as claimed in claim 9, further comprising a second memory controller configuring the local memory according to the first degree and the second degree.

12. The graphics processing system as claimed in claim 9, wherein the first memory controller further configures the local memory according to the first degree and the second degree.

13. The graphics processing system as claimed in claim 1, further comprising a second window filter filtering the output image output from the first window filter.

14. A graphics processing system for processing an input image to an output image, comprising:
a memory buffer comprising a first number of a plurality of line buffers for storing the input image;
a sampling unit sampling a plurality of sampling points of the input image;
a scaling unit scaling the sampling points by a sampling polynomial equation;
a local memory for storing data corresponding to the scaled sampling points and a portion of the input image;
a first window filter filtering the data corresponding to the scaled sampling points and the portion of the input image by a first filter polynomial equation to generate the output image; and
a first memory controller configuring the local memory according to the sampling polynomial equation and the first filter polynomial equation.

15. The graphics processing system as claimed in claim 14, wherein the sampling polynomial equation is a first degree and the first filter polynomial equation is a second degree.

16. The graphics processing system as claimed in claim 15, wherein the first number of the line buffers is determined according to the first degree and the second degree.

17. The graphics processing system as claimed in claim 16, further comprising a second memory controller determining the first number of the line buffers according to the first degree and the second degree.

18. The graphics processing system as claimed in claim 17, wherein the local memory has the buffer width, and a memory height of the power of 2 and exceeding or equal to the first degree and the second degree.

19. The graphics processing system as claimed in claim 18, wherein the output image is stored in a system memory through a bus with a bus bandwidth.

20. The graphics processing system as claimed in claim 19, wherein the buffer width is determined according to the bus bandwidth.

21. The graphics processing system as claimed in claim 20, wherein the line buffer has the buffer width and a buffer depth.

22. The graphics processing system as claimed in claim 21, wherein the buffer depth is determined according to an image width of the input image.

23. The graphics processing system as claimed in claim 14, further comprising a second window filter filtering the output image output from the first window filter.

24. The graphics processing system as claimed in claim 14, wherein the local memory comprises a plurality of local buffers, wherein one of the local buffer stores data corresponding to the scaled sampling points, and the other local buffers store the input image corresponding to the others line buffers.

25. The graphics processing system as claimed in claim 14, further comprising a filter controller outputting data stored in the local memory to the first window filter.

26. The graphics processing system as claimed in claim 16, wherein the first memory controller further configures the buffer memory according to the first degree and the second degree.
